(19) United States
(12) Patent Application Publication
(10) Pub. No.: US 2003/0026946 A1
(43) Pub. Date: Feb. 6, 2003

(54) Snow removal sheet

(76) Inventor: Chheang Seav Chhun, Revere, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/074,198

(22) Filed: Feb. 12, 2002

Related U.S. Application Data
(60) Provisional application No. 60/310,317, filed on Aug. 6, 2001.
(60) Provisional application No. 60/334,778, filed on Dec. 3, 2001.

(51) Int. Cl. B32B 3/10

(52) U.S. Cl. 428/131

(57) ABSTRACT

A foldable snow removal sheet. The sheet includes a central portion. At least one handle is provided at one end of the sheet and along each side of the sheet. The handles are integrally formed with the sheet. The sheet may be disposed over an area in advance of snow accumulation. Following the accumulation of snow on the sheet, the snow may be removed by lifting the handles to roll or move the snow off the sheet. Multiple sheets may be employed for snow removal from areas greater than the area accomodated with a single snow removal sheet.

### CROSS REFERENCE TO RELATED APPLICATIONS

The present application claims priority under 35 U.S.C. §119(e) of U.S. Provisional Application No. 60/310,317 titled Snow Removal Foldable Sheet, filed Aug. 6, 2001 and U.S. Provisional Application No. 60/334,778 titled Snow Removal Foldable Sheet, filed Dec. 3, 2001.

### STATEMENT REGARDING FEDERALLY SPONSORED RESEARCH OR DEVELOPMENT

Not Applicable

### BACKGROUND OF THE INVENTION

The present invention pertains to lightweight foldable sheet that may be used for snow removal and to a method for using such a sheet for the purpose of snow removal.

It is often necessary to remove snow from walks, patios and driveways in cold climates. Typically snow shovels, snowblowers and snow plows are employed for this purpose. The use of snowplows is typically limited to large areas such as driveways since the plows are usually attached to large vehicles. Thus, snowplows are not normally used for clearing snow from patios and walkways. Additionally, most individuals do not own snowplows or the vehicles to which the plows are attached due to the cost and complexity of operating such equipment as well as the problem of storing the plow when it is not in use. When snow plows are employed for snow removal they are typically employed by contractors that are hired at considerable expense.

Many homeowners utilize snowblowers for the purpose of snow removal. While snowblowers are an effective means for removing snow from driveways, patios and walks of small to moderate size, snowblowers are costly and many individuals are uncomfortable using such power equipment.

Snow shovels or often employed for snow removal. These devices are generally of low-cost, however, substantial effort is required to clear even a small to moderate sized area using a snow shovel. The use of such devices is known to cause or aggravate back problems as a result of the heavy lifting that is required.

It would therefore be desirable to have a simple and low-cost technique for removing snow from areas of small to moderate size.

### BRIEF SUMMARY OF THE INVENTION

In accordance with the present invention a lightweight foldable snow removal sheet is disclosed. The snow removal sheet is preferably formed of a thin plastic material such as high-density polyethylene. The snow removal sheet includes a generally rectangular central portion having first and second opposing ends and opposing sides. At least one handle extends from the first end of the central portion. Additionally, at least one handle extends from each of the opposing sides of the central portion of the sheet at the distal and of the respective side from the first end. In one embodiment, two handles extend from the first end of the central portion and two handles extend from each side of the central portion.

When a user is expecting a snowfall, one or more of the snow removal sheets are placed over the area to be cleared of snow. A typical sheet may be approximately four feet wide by eight feet long. Snow removal may be achieved over a larger area than can be achieved with a single sheet by using multiple sheets that are disposed side by side and/or end to end. Weights are typically placed on the corners of each sheet to prevent the sheet from being blown away. Once snow accumulates on the sheet, the weights are removed from the corners of the snow removal sheet and a user may lift the snow removal sheet by the handles on the first end to roll the snow off the second end of the sheet by pulling the first end of the sheet toward the second end of the sheet. Alternatively, a user may grab the handles on a side of the sheet and roll the snow diagonally off the sheet by lifting the handles and pulling the sheet toward the diagonally opposing corner of the sheet.

In one embodiment of the presently disclosed foldable snow removal sheet the handles are integrally formed with the central sheet portion.

Other aspects, features and advantages of the presently disclosed snow removal sheet will be apparent to those of ordinary skill in the art from the detailed description of the invention that follows.

### BRIEF DESCRIPTION OF THE SEVERAL VIEWS OF THE DRAWING

The invention will be more fully understood by reference to the following detailed description of the invention in conjunction with the drawing over which:

FIG. 1 is a top plan view of a foldable snow removal sheet in accordance with the present invention prior to formation of the end and side handles;

FIG. 2 is a top plan view of the foldable snow removal sheet of FIG. 1 following folding of the handle tabs and affixing the handle tabs to the central sheet portion;

FIG. 3 is a pictorial representation showing the use of the snow removal sheet or FIG. 1 for the removal of snow;

FIG. 4 is a top plan view of one embodiment of a handle for use with a snow removal sheet;

FIG. 5 is a top plan view of another embodiment of a snow removal sheet; and

FIG. 6 is a top plan view of yet another embodiment of a snow removal sheet.

### DETAILED DESCRIPTION OF THE INVENTION

U.S. Provisional Application No. 60/310,317 filed Aug. 6, 2001 and titled Snow Removal Foldable Sheet and U.S. Provisional Application No. 60/334,778 titled Snow Removal Foldable Sheet, filed Dec. 3, 2001 are incorporated herein by reference.

In accordance with the present invention a lightweight foldable snow removal sheet is disclosed. The snow removal sheet provides a low cost alternative to snow plowing services, snowblowers and snow shovels for performing snow removal from small to moderately sized areas.

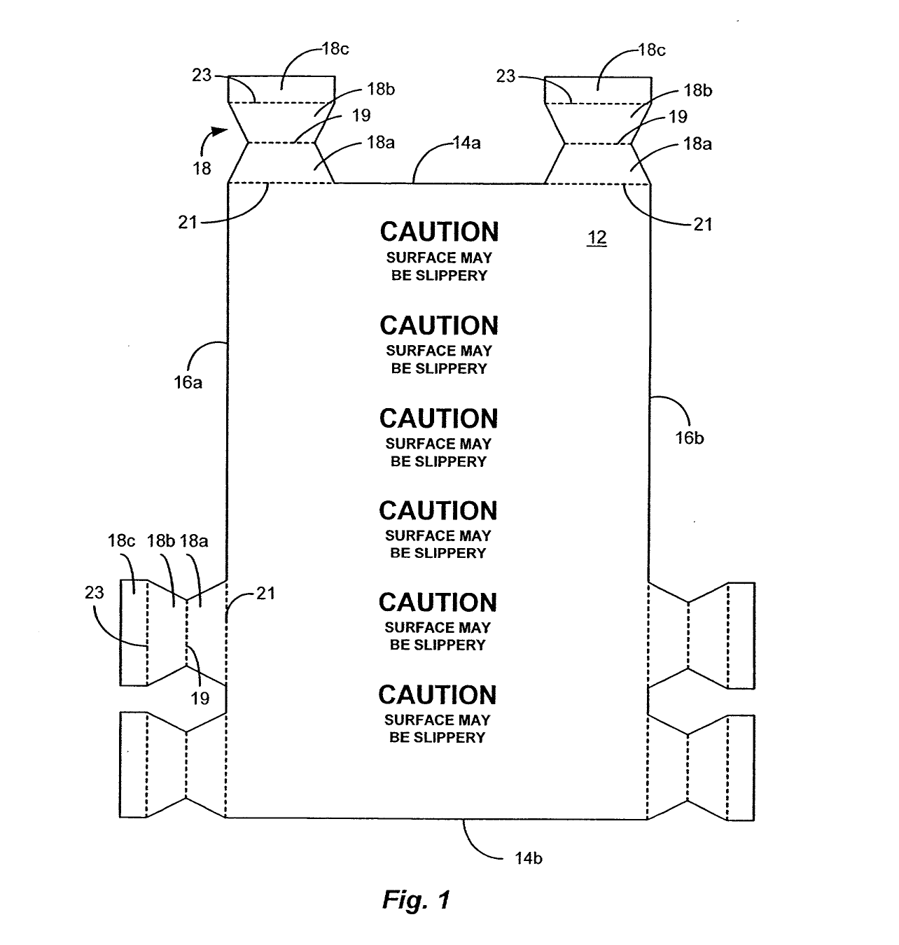

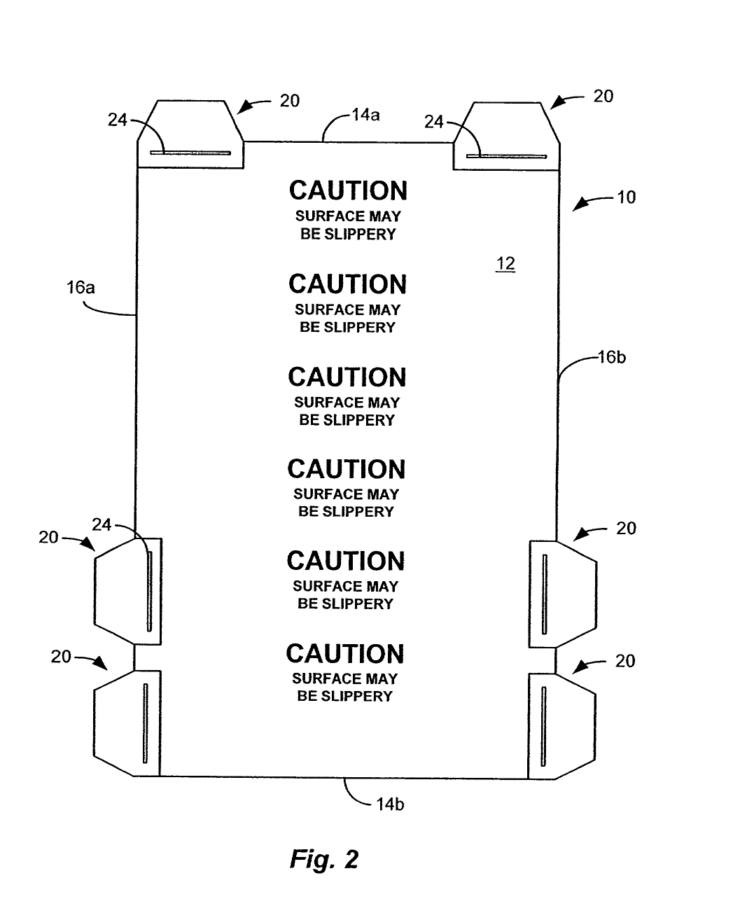

A snow removal sheet 10 in accordance with the present invention is depicted in FIGS. 1 and 2. FIG. 1 depicts a top plan view of the sheet 10 prior to the formation of handles and FIG. 2 depicts a top plan view of the sheet 10 after the formation of the handles. Referring to FIG. 1, the sheet 10 includes a generally rectangular central sheet portion 12 having first and second ends 14a and 14b respectively, and opposing sides 16a and 16b. In one embodiment, the sheet 10 includes integrally formed handle tab extensions 18 that include first, second and third tab portions 18a, 18b and 18c respectively. The tab extensions 18 are formed into handles as subsequently discussed in greater detail. The first tab portion 18a is adjacent the central portion 12 of the sheet 10 and extends from the central portion 12. The second tab portion 18b of the tab extension 18 has a shape that generally mirrors the shape of the first tab portion 18a. The second tab portion 18b extends from the first tab portion 18a. As shown, the third tab portion 18c extends from the second tab portion 18b. The central sheet portion 12 the first, second and third tab portions are fabricated as a continuous unitary sheet.

In one embodiment, the foldable snow removal sheet 10 is fabricated out of a plastic material, such as high-density polyethylene. For a typical snow removal sheet 10 fabricated of high-density polyethylene the sheet is between 0.002 inch and 0.00275 inch to achieve the desired strength for the sheet. It should be recognized that snow removal sheets having greater strengths may be provided using thicker sheet materials. Other suitable sheet materials including plastic sheets may be used. For example, vinyl, kevlar, treated waterproof nylon sheets and specially treated waterproof cloths may be employed for the presently disclosed foldable snow removal sheet 10.

To form the handles 20 (FIG. 2) the tab extensions 18 are each folded generally at the intersection of the first tab portion 18a and the second tab portion 18b as depicted by dashed line 19. Dashed line 21 serves to identify the intersection between the central sheet portion 12 and the first handle portion 18a and dashed line 23 serves to identify the intersection between the second handle portion 18b and the third handle portion 18c. After folding of the second tab portion 18b over the first tab portion 18a, the third tab portion 18c overlays the central sheet portion 12 as apparent in FIG. 2. An impulse sealer is used to bond the third tab portion 18c to the central sheet portion 12 to form a looplike handle 20. The impulse sealer heats the plastic to a temperature sufficient to momentarily melt the plastic material and to cause the third tab portion 18c and the underlying central sheet portion 12 to be permanently bonded one to the other along the length of the bond 24. Alternatively, the third tab portion 18c may be bonded to the central portion 12 via the use of any suitable adhesive. The bond 24 may extend along a substantial portion of the width of the handle 20 so that the forces applied to the bond 24 are spread across the length of the bond 24. A user may insert their hands inside the handles 20 to obtain a firm grip on the sheet.

As depicted in FIG. 2, first and second handles 20 are provided on opposing sides of the first end 14a of the central portion 12. Additionally, two handles 20 extend from the first side 16a of the central portion 12. The handles extending from the first side of the sheet are located at the distal end of the first side 16a from the first end 14a. Similarly, two handles 20 extend from the second side of the central portion 12 of the sheet 10 and these handles are also located at the distal end of the second side 16b from the first end 14a of the central portion 12.

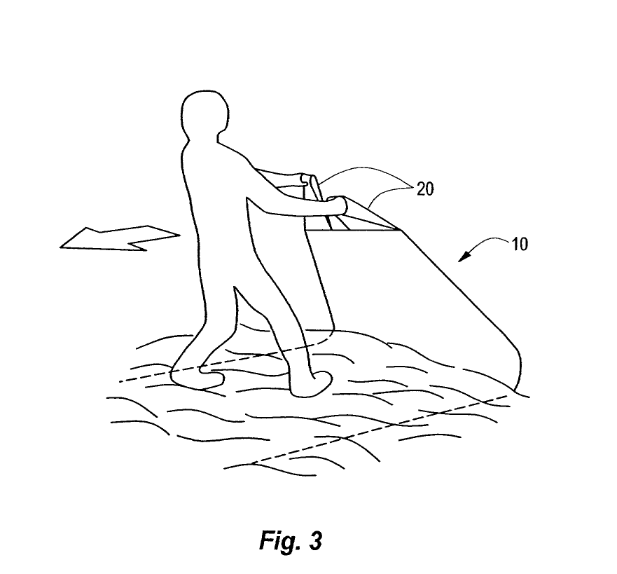

As depicted in FIG. 3, as user may lift the sheet 10 using the handles 20 extending from the first end 14a of the sheet 10 and roll or move snow that has accumulated on the central portion 12 of the sheet 10 toward to second end 14b and off of the sheet 10. Snow removal via this technique may be accomplished with comparatively little effort. Furthermore, a pair of handles 20 extending from a side of the sheet 10 may be lifted and pulled toward the diagonally opposing corner to clear the snow from the area covered by the sheet.

Indicia 26, such as warnings, may be written on the sheet to caution a user that the surface may be slippery.

The snow removal sheets herein disclosed are constructed of a thin, light and flexible material that may be readily folded for purposes of storage and are preferably fabricated of a waterproof or water-resistant material.

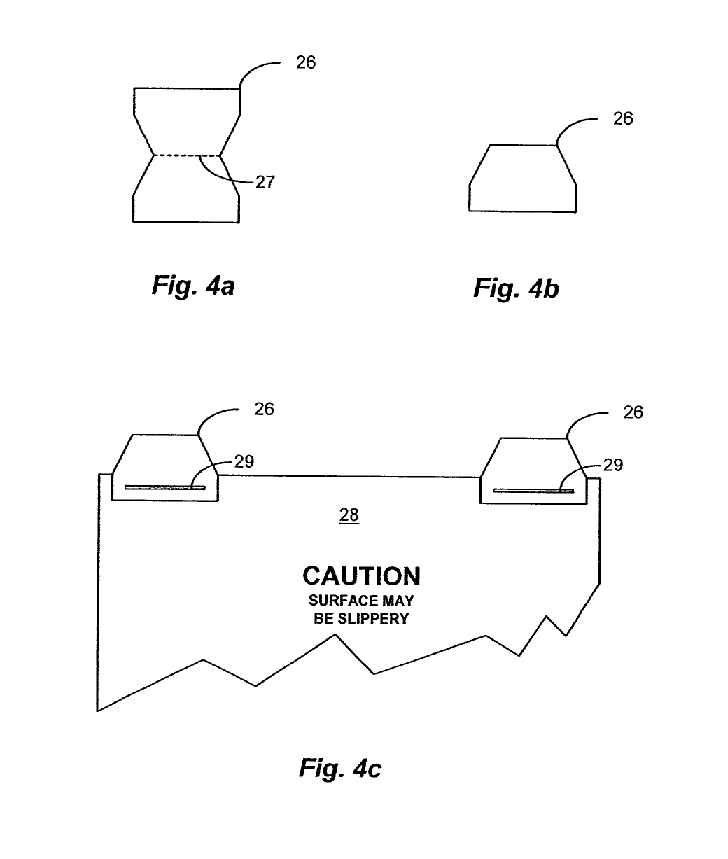

While the embodiment depicted in FIGS. 1 and 2 includes handles 20 integrally formed with the central sheet portion 20, the handles may be fabricated separately and affixed to the central sheet portion. More specifically, as depicted in FIG. 4a, a handle 26 may be folded at the location indicated by the dashed line 27. After folding of the handle 26 as shown in FIG. 4b, handles 26 may be affixed to a generally rectangular central sheet portion 28 via use of an impulse sealer to produce bonding areas 29 as shown in FIG. 4c. Alternatively, the handles 26 may be affixed to the central sheet portion using any suitable adhesive known in the art.

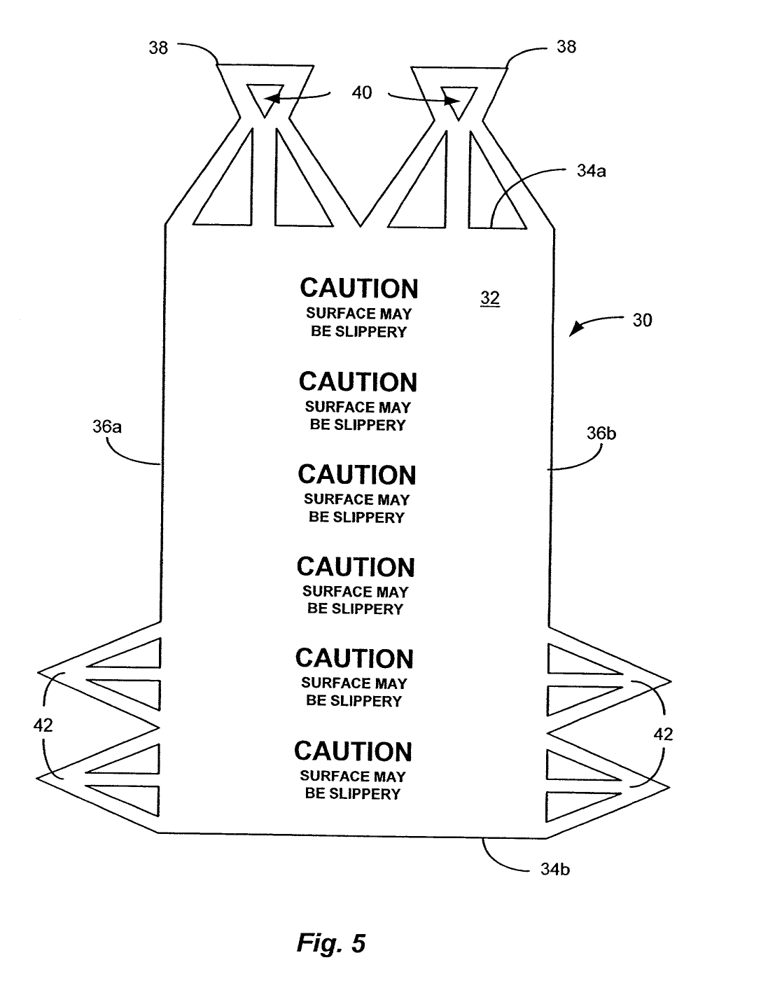

Another embodiment of a foldable snow removal sheet in accordance with the invention is depicted in FIG. 5. Referring to FIG. 5, the snow removal sheet 30 includes a central sheet portion 32, first and second ends 34a and 34b respectively and first and second sides 36a and 36b. A pair of handles 38 are provided at the first end 34a of the sheet that are integrally formed with the sheet as a continuous part of the sheet 30. Openings 40 within the handles 38 allow a user to easily grip the handles 38. Handles 42 are also provided on the first and second sides of the central sheet portion 32 at the end of the respective side that is distal from the first end 34a.

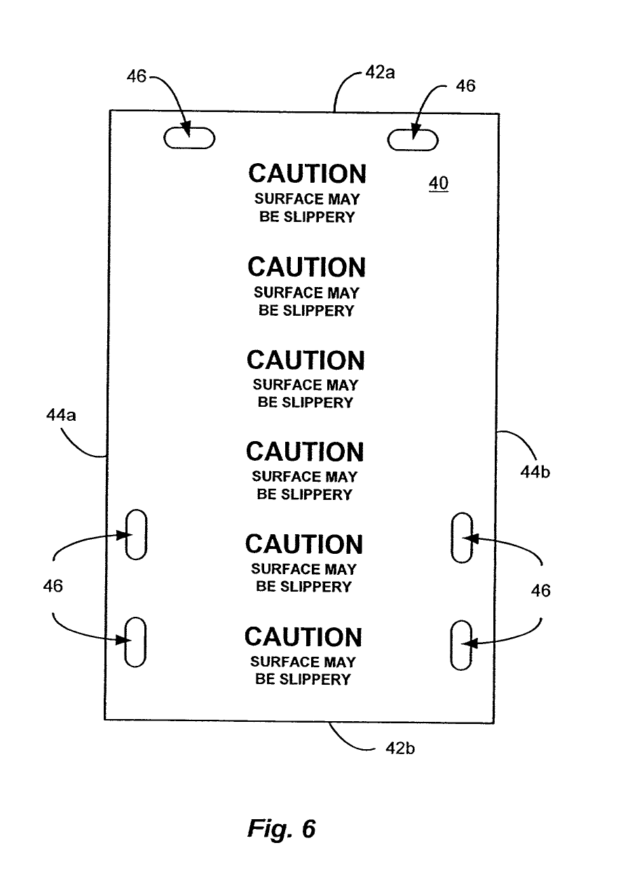

In another embodiment of a snow removal sheet depicted in FIG. 6, the sheet 40 has first and second ends 42a and 42b and first and second sides 44a and 44b. Openings 46 are provided inboard of the first end 42a of the sheet 40 and inboard of the first and second sides 44a and 44b at the end of the respective side most distal from the first end 42a. The openings 46 are sized to permit the hand of a user to be inserted through the respective opening 46. The openings 46 within the sheet 40 provide handles that may be employed for gripping of the sheet 40 during the snow removal process described above.

It should be apparent to those of ordinary skill in the art that variations of and modifications to the above described foldable snow removal sheet may be made without departing from the inventive concepts disclosed herein. Accordingly, the invention should not be viewed as limited except by the scope and spirit of the appended claims.

What is claimed is:

1. A snow removal sheet comprising:
a generally rectangular central sheet portion having first and second opposing ends and first and second opposing sides, said generally rectangular central sheet portion being formed of a specified material;
at least one first handle extending from said first end of said sheet;
at least one second handle extending from said first side of said sheet; and
at least one third handle extending from said second side of said sheet,
said at least one first, second and third handles being formed of said specified material.

2. The snow removal sheet of claim 1 wherein said at least one first, second and third handles are integrally formed with said generally rectangular central sheet portion.

3. The snow removal sheet of claim 1 wherein said at least one first, second and third handles are mounted to said generally rectangular central sheet portion.

4. The snow removal sheet of claim 1 wherein said first and second opposing ends have a first length and said first and second opposing sides have a second length, and said second length is greater than said first length.

5. The snow removal sheet of claim 1 wherein said specified material comprises a plastic.

6. The snow removal sheet of claim 5 wherein said specified material comprises a high density polyethylene.

7. The snow removal sheet of claim 5 wherein said sheet has a thickness of between 0.002 inch and 0.00275 inch.

8. The snow removal sheet of claim 1 wherein said specified material comprises a vinyl sheet.

9. The snow removal sheet of claim 1 wherein at least one of said first, second and third handles has a first handle portion, a second handle portion and a third handle portion, said first handle portion comprising an extension of said sheet, said second handle portion comprising an extension from said first handle portion and said third handle portion comprising an extension from said second handle portion, said at least one handle being folded at the intersection between said first and second handle portions, said third handle portion being affixed to said generally rectangular central sheet portion to form a looped handle.

10. The snow removal sheet of claim 1 wherein each of said at least one first, second and third handles has a first handle portion, a second handle portion and a third handle portion, said first handle portion comprising an extension of said sheet, said second handle portion comprising an extension from said first handle portion and said third handle portion comprising an extension from said second handle portion, each handle being folded at the intersection between the respective first and second handle portion, said third handle portion being affixed to said generally rectangular central sheet portion to form a looped handle.

11. The snow removal sheet of claim 1 wherein said at least one first handle comprises two first handles extending from said first end of said generally rectangular sheet portion, said at least one second handle comprises two second handles extending from said first side of said generally rectangular sheet portion and said at least one third handles comprises two third handles extending from said second side of said generally rectangular sheet portion.

12. The snow removal sheet of claim 11 wherein one of said two first handles extends from said first end of said generally rectangular sheet adjacent said first side of said generally rectangular sheet and the other one of said two first handles extends from said first end of said generally rectangular sheet adjacent said second side of said generally rectangular sheet.

13. The snow removal sheet of claim 11 wherein said two second handles extend from said first side of said generally rectangular central sheet portion at the distal end of said first side from said first end and wherein said two third handles extend from said second side of said generally rectangular central sheet portion at the distal end of said second side from said first end.

14. The snow removal sheet of claim 13 wherein said two second handles are in generally opposed relation with respect to said two third handles.

15. The snow removal sheet of claim 1 wherein said at least one first handle includes at least one opening to permit gripping of the respective handle through the opening.

16. The snow removal sheet of claim 1 further including printed indicia on said central sheet portion, wherein said printed indicia comprise at least one safety warning.

17. A snow removal sheet comprising:
a generally rectangular central sheet portion having first and second opposing ends and first and second opposing sides, said generally rectangular central sheet portion being formed of a specified material;
said generally rectangular sheet having at least one first opening inboard of said first end of said sheet and adjacent said first end to permit the hand of a user to be extended through said said at least one first opening to permit gripping of said sheet along said first end;
said generally rectangular sheet having at least one second opening inboard of said first side of said sheet and adjacent said first side of said sheet to permit the hand of the user to be extended through said at least one second opening to permit gripping of said sheet along said first side; and
said generally rectangular sheet having at least one third opening inboard of said second side of said sheet and adjacent said second side of said sheet to permit the hand of the user to be extended through said at least one third opening to permit gripping of said sheet along said second side.

18. The snow removal sheet of claim 17 wherein said sheet comprises a generally waterproof material.

19. The snow removal sheet of claim 17 wherein said sheet includes at least two first openings, at least two second openings and at least two third opernings.

20. The snow removal sheet of claim 19 wherein said at least one second opening is located at the distal end of said first side from said first end and wherein said at least one third opening is located at the distal end of said second side from said first end.

21. A method for removal snow from a predetermined area comprising the steps of:
placing a sheet over said predetermined area, wherein said sheet has a generally rectangular central sheet portion having first and second opposing ends and first and second opposing sides and at least one handle integrally formed with said generally rectangular sheet portion and extending from said first end of said generally rectangular sheet central sheet portion;
allowing snow to accumulate on said sheet; and
lifting said sheet using and at least one handle and pulling said at least one handle toward said second end to move said snow toward said second end of said sheet and off of said sheet.

22. The method of claim 21 wherein said at least one handle comprises two handles.
